(19) United States
(12) Patent Application Publication
(10) Pub. No.: US 2026/0141808 A1
(43) Pub. Date: May 21, 2026

(54) ATTENTION CALLING SYSTEM, ATTENTION CALLING METHOD, AND STORAGE MEDIUM

(71) Applicant: HONDA MOTOR CO., LTD., Tokyo (JP)

(72) Inventors: Yuichiro Shimura, Wako-shi (JP); Toshihiro Hashimoto, Wako-shi (JP); Tsuyoshi Nojiri, Wako-shi (JP); Haruko Okuyama, Wako-shi (JP); Tatsuya Iwasa, Wako-shi (JP)

(21) Appl. No.: 19/351,507

(22) Filed: Oct. 7, 2025

(30) Foreign Application Priority Data
Nov. 18, 2024 (JP) 2024-200927

(51) Int. Cl. G08G 1/16; G06V 20/58

(52) U.S. Cl. CPC G08G 1/16; G06V 20/58

(57) ABSTRACT

An attention calling system includes: a monitoring-target object recognition section that recognizes a monitoring-target object existing around a moving object; and an attention calling control section that executes attention calling processing for a user. When the monitoring-target object is recognized by the monitoring-target object recognition section in a state where a predetermined output via sound or light from a predetermined area around the user is being performed by the output device, the attention calling control section executes, as the attention calling processing, processing of reducing an output level of the predetermined output from a direction of the monitoring-target object to less than an output level of the predetermined output from directions other than the direction of the monitoring-target object. The direction of the monitoring-target object is a direction from the user toward the monitoring-target object.

### INCORPORATION BY REFERENCE

The present application claims priority under 35 U.S.C. § 119 to Japanese Patent Application No. 2024-200927 filed on Nov. 18, 2024. The content of the application is incorporated herein by reference in its entirety.

### BACKGROUND OF THE INVENTION

### Field of the Invention

The present invention relates to an attention calling system, an attention calling method, and a storage medium.

### Description of the Related Art

Conventionally, there has been known a technology by which, regarding a target captured image generated based on a captured image of a scene around a vehicle, when an object is recognized that is moving from a region outside of the target captured image toward the center thereof, a plurality of indicators, which shines for a certain period of time and then ceases shining, is sequentially displayed at different positions from the outside region toward the center (for example, see Japanese Patent No. 5692403).

When attention of a user aboard a moving object, such as a vehicle, is called to a target object being approached by the moving object through image display or sound output as in the above-described related art, it would be difficult for the user to notice the call for attention in a situation where some content, such as music or radio broadcasting, is being outputted within the moving object, because the user is distracted by the content. Accordingly, it is conceivable that the sound level of the content is lowered when the call for attention is issued. However, there is a possibility that the lowered sound level will inconvenience the user.

Accordingly, an object of the present application is to provide an attention calling system that can call attention of a user aboard a moving object to a monitoring-target object, while curbing inconvenience felt by the user. Ultimately, a contribution is made to further improvement in traffic safety, and development of sustainable transportation systems.

### SUMMARY OF THE INVENTION

As a first aspect to achieve the object, an attention calling system is provided that includes: a monitoring-target object recognition section that recognizes a monitoring-target object existing around a moving object; and an attention calling control section that, when the monitoring-target object is recognized by the monitoring-target object recognition section, executes attention calling processing using an output device for a user aboard the moving object, the output device outputting sound or light, wherein the output device outputs sound or light from a predetermined area around a boarding position of the user in the moving object, and when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.

In the attention calling system, the attention calling control section may be configured to, in the attention calling processing, intermittently reduce the output level of the predetermined output from the direction of the monitoring-target object.

In the attention calling system, the attention calling control section may be configured to, in the attention calling processing, change an interval at which the output level of the predetermined output from the direction of the monitoring-target object is intermittently changed, according to a degree of risk of the monitoring-target object being recognized by the monitoring-target object recognition section.

In the attention calling system, the output device outputs sound, and the attention calling system may further include a sound detection section that detects sound in a boarding space in the moving object, wherein the attention calling control section may be configured to, in the attention calling processing, reduce a level of the predetermined output via sound from the direction of the monitoring-target object to less than a level of the predetermined output via sound from directions other than the direction of the monitoring-target object by reducing a level of sound outputted from the direction of the monitoring-target object to less than a level of the sound detected by the sound detection section.

In the attention calling system, the output device outputs sound, and the attention calling control section may be configured to cause the output device to output an attention calling sound from the direction of the monitoring-target object when a degree of risk of the monitoring-target object being recognized by the monitoring-target object recognition section is a predetermined determination degree or more.

In the attention calling system, the output device outputs light, and the attention calling system may further include a brightness detection section that detects brightness in a boarding space in the moving object, wherein the attention calling control section may be configured to, in the attention calling processing, reduce a level of the predetermined output via light from the direction of the monitoring-target object to less than a level of the predetermined output via light from directions other than the direction of the monitoring-target object by reducing a level of brightness of light outputted from the direction of the monitoring-target object to less than a level of the brightness detected by the brightness detection section.

In the attention calling system, the output device outputs light, and the attention calling control section may be configured to cause the output device to output attention calling light from the direction of the monitoring-target object when a degree of risk of the monitoring-target object being recognized by the monitoring-target object recognition section is a predetermined determination degree or more.

As a second aspect to achieve the object, an attention calling method to be executed by a computer is provided that includes: a monitoring-target object recognition step of recognizing a monitoring-target object existing around a moving object; and an attention calling control step of, when the monitoring-target object is recognized in the monitoring-target object recognition step, executing attention calling processing using an output device for a user aboard the moving object, the output device outputting sound or light, wherein the output device outputs sound or light from a predetermined area around a boarding position of the user in the moving object, and in the attention calling control step, when the monitoring-target object is recognized in the monitoring-target object recognition step in a state where a predetermined output via sound or light from the predetermined area is being performed by the output device, processing of reducing an output level of the predetermined output from a direction of the monitoring-target object to less than an output level of the predetermined output from directions other than the direction of the monitoring-target object is performed as the attention calling processing, the direction of the monitoring-target object being a direction from the user toward the monitoring-target object.

As a third aspect to achieve the object, a non-transitory computer-readable storage medium storing a program is provided that causes a computer to function as: a monitoring-target object recognition section that recognizes a monitoring-target object existing around a moving object; and an attention calling control section that, when the monitoring-target object is recognized by the monitoring-target object recognition section, executes attention calling processing using an output device for a user aboard the moving object, the output device outputting sound or light, wherein the output device outputs sound or light from a predetermined area around a boarding position of the user in the moving object, and when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.

According to the attention calling system, the attention calling method, and the storage medium, it is possible to call attention of a user aboard a moving object to a monitoring-target object, while curbing inconvenience felt by the user.

### BRIEF DESCRIPTION OF THE DRAWINGS

FIG. 1 is an explanatory diagram of a vehicle equipped with an attention calling system;

FIG. 2 is a configuration diagram of the attention calling system;

FIG. 3 is a flowchart of attention calling processing;

FIG. 4 is an explanatory diagram of the attention calling processing by muting; and

FIG. 5 is an explanatory diagram of the attention calling processing by extinguishing light.

### DETAILED DESCRIPTION OF THE INVENTION

[1. Configuration of Vehicle Equipped with Attention Calling System]

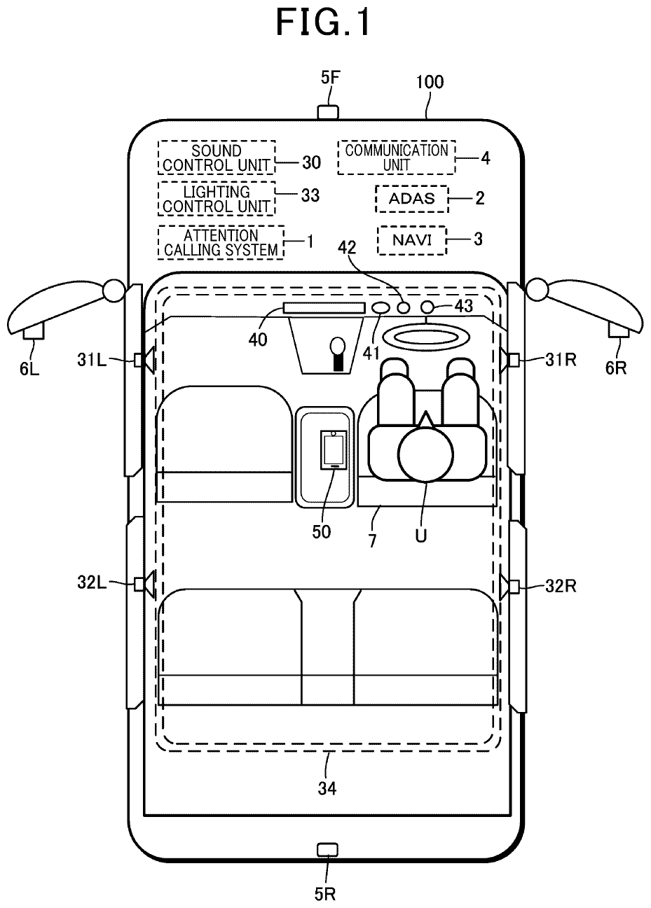

With reference to FIG. 1, a configuration of a vehicle 100 equipped with an attention calling system 1 according to the present embodiment is described. The attention calling system 1 performs attention calling processing for a user U in (aboard) the vehicle 100. The user U is a driver of the vehicle 100, and the vehicle 100 corresponds to a moving object in the present disclosure.

In addition to the attention calling system 1, the vehicle 100 includes an ADAS (Advanced Driver-Assistance System) 2, a navigation apparatus 3, a communication unit 4, a sound control unit 30, a lighting control unit 33, a touch-panel display 40, a driver seat speaker 41, a driver seat microphone 42, and a driver camera 43.

Moreover, the vehicle 100 includes a front camera 5F that captures a scene in front of the vehicle 100, a rear camera 5R that captures a scene behind the vehicle 100, a left side camera 6L that captures a scene to the left side of the vehicle 100, and a right side camera 6R that captures a scene to the right side of the vehicle 100.

Furthermore, the vehicle 100 includes a left front speaker 31L installed forward of the driver seat 7 on the left, a right front speaker 31R installed forward of the driver seat 7 on the right, a left rear speaker 32L installed behind the driver seat 7 on the left, a right rear speaker 32R installed behind the driver seat 7 on the right, and ambient lighting 34 arranged along the entire periphery of a ceiling portion of a vehicle cabin. The left front speaker 31L, the right front speaker 31R, the left rear speaker 32L, and the right rear speaker 32R correspond to an output device that outputs sound in the present disclosure. The ambient lighting 34 corresponds to an output device that outputs light in the present disclosure. The output device that outputs light may be non-continuous lights installed at a plurality of places, such as a plurality of spot lights that outputs light from around the user U. The output device that outputs sound or light in the present disclosure may be HMIs (Human Machine Interfaces) that are configured by arranging speakers, lights, displays, and the like in a 360-degree area around the driver seat 7. When such HMIs are included, the output level of sound or light from an HMI in a direction in which attention of the user U sitting in the driver seat 7 is to be directed is lowered (including the output being turned off), whereby the attention calling processing, which will be described later, can be executed.

The ADAS 2 is configured by a computer and recognizes a monitoring-target object (another vehicle, a pedestrian, an obstacle, or the like) existing around the vehicle 100 and perform various driving assistance control, based on images captured by the front camera 5F, the rear camera 5R, the left side camera 6L, and the right side camera 6R. The driving assistance control includes ACC (Adaptive Cruise Control System), FCW (Forward Collision Warning), AEBS (Advanced Emergency Braking System), BSM (Blind Spot Monitoring), and the like.

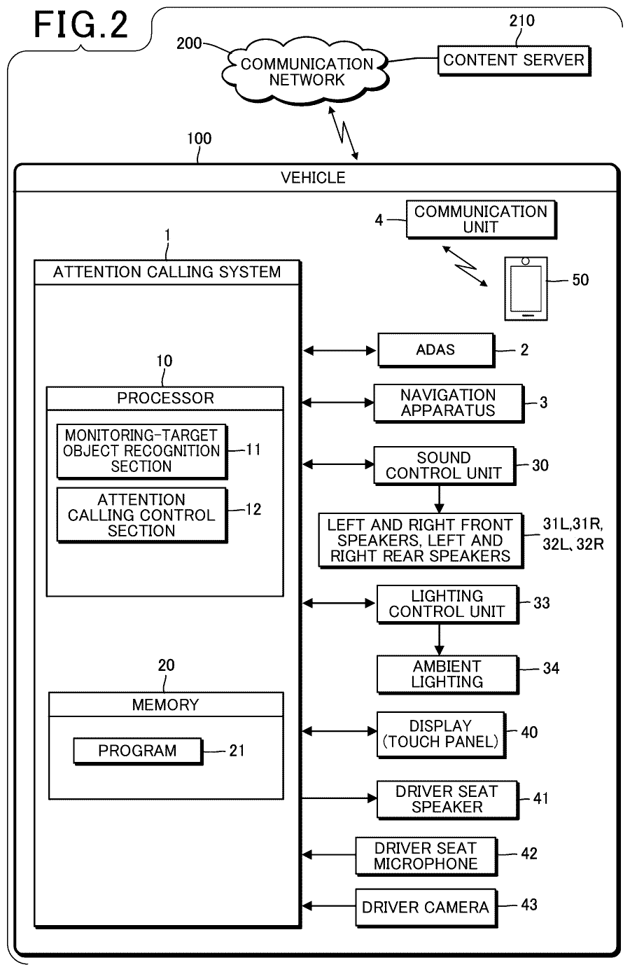

The navigation apparatus 3 is configured by a computer and performs route guidance to a destination and the like, based on the current position of the vehicle 100 and map information. The communication unit 4 includes a transmitter and a receiver and performs communication with a mobile terminal 50 (a smartphone, a tablet terminal, a mobile telephone, or the like) brought by the user U into the vehicle 100. Moreover, as shown in FIG. 2, the communication unit 4 performs communication with an external communication system, such as a content server 210, via a communication network 200.

For audio content, such as music or a talk, the sound control unit 30 is configured by a computer and controls sound output from the left front speaker 31L, the right front speaker 31R, the left rear speaker 32L, and the right rear speaker 32R. The lighting control unit 33 is configured by a computer and controls the output level (amount of light) and the irradiation range of the ambient lighting 34.

### [2. Configuration of Attention Calling System]

With reference to FIG. 2, a configuration of the attention calling system 1 is described. Note that the attention calling system 1 may be configured as part of the functionality of an on-board apparatus, such as the ADAS 2 or the navigation apparatus 3, or may be a dedicated on-board apparatus. The attention calling system 1 is a control unit including a processor 10, memory 20, and the like. The processor 10 corresponds to a computer in the present disclosure.

The attention calling system 1 is connected to the ADAS 2, the navigation apparatus 3, the sound control unit 30, the lighting control unit 33, the display 40, the driver seat speaker 41, the driver seat microphone 42, and the driver camera 43. A program 21 and the like for controlling the attention calling system 1 are stored in the memory 20. The processor 10 functions as a monitoring-target object recognition section 11 and an attention calling control section 12 by reading and executing the program 21.

The monitoring-target object recognition section 11 recognizes the presence or absence of a monitoring-target object existing around the vehicle 100 and a degree of risk of the monitoring-target object, by acquiring, through communication with the ADAS 2, monitored information on the surroundings of the vehicle 100 being recognized by the ADAS 2. For example, the monitoring-target object recognition section 11 recognizes a higher degree of risk of the monitoring-target object as the monitoring-target object comes nearer to the vehicle 100. The monitoring-target object recognition section 11 may calculate a degree of risk by calculating a distance to the monitoring-target object existing around the vehicle 100 by using a vehicle-to-vehicle communication apparatus, a GNSS unit, V2X (road-to-vehicle, vehicle-to-pedestrian, or the like) communication, or the like.

The attention calling control section 12 recognizes, through communication with the sound control unit 30, output states of sound from the left front speaker 31L, the right front speaker 31R, the left rear speaker 32L, and the right rear speaker 32R controlled by the sound control unit 30. Moreover, the attention calling control section 12 controls the output levels (including turning off the outputs) of sound from the left front speaker 31L, the right front speaker 31R, the left rear speaker 32L, and the right rear speaker 32R via the sound control unit 30, through communication with the sound control unit 30.

The attention calling control section 12 recognizes, through communication with the lighting control unit 33, a lit state of the ambient lighting 34 being controlled by the lighting control unit 33. Moreover, the attention calling control section 12 controls the lit area and the light-emitting level (including extinguishing light) of the ambient lighting 34 via the lighting control unit 33.

When a monitoring-target object is recognized by the monitoring-target object recognition section 11, the attention calling control section 12 performs attention calling processing of notifying the user U of a direction in which the monitoring-target object exists. Details of the attention calling processing is described below.

### [3. Attention Calling Processing]

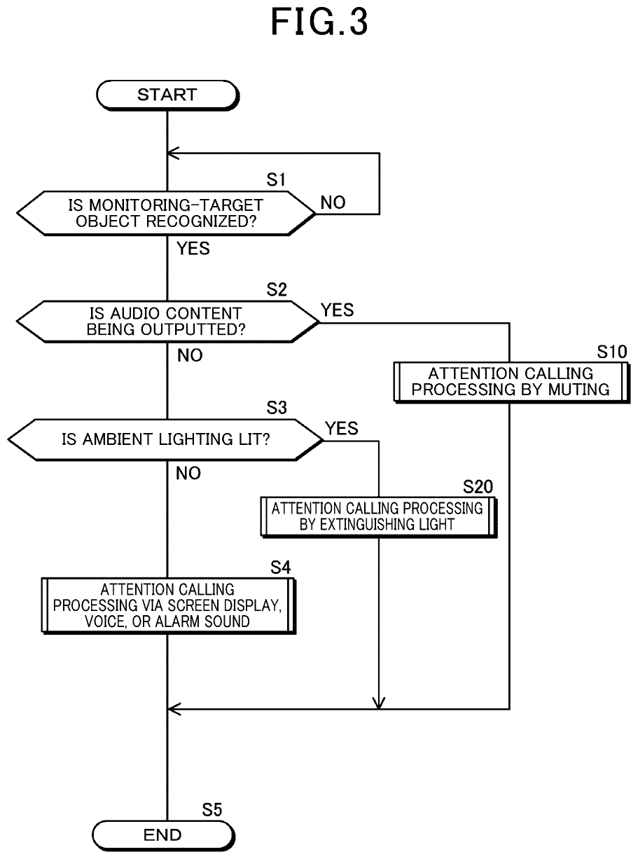

A procedure for the attention calling processing that is executed by the attention calling system 1 is described by following a flowchart shown in FIG. 3. The attention calling system 1 executes the processing according to the flowchart shown in FIG. 3 repeatedly while the vehicle 100 is traveling. In step S1 in FIG. 3, the monitoring-target object recognition section 11 determines, based on communication with the ADAS 2, the presence or absence of a monitoring-target object existing around the vehicle 100. When a monitoring-target object is recognized, the monitoring-target object recognition section 11 advances the processing to step S2.

In step S2, the attention calling control section 12 determines, based on control by the sound control unit 30, whether or not audio content is being outputted from the left front speaker 31L, the right front speaker 31R, the left rear speaker 32L, and the right rear speaker 32R. Then, the attention calling control section 12 advances the processing to step S10 when audio content is being outputted, and advances the processing to step S3 when audio content is not being outputted.

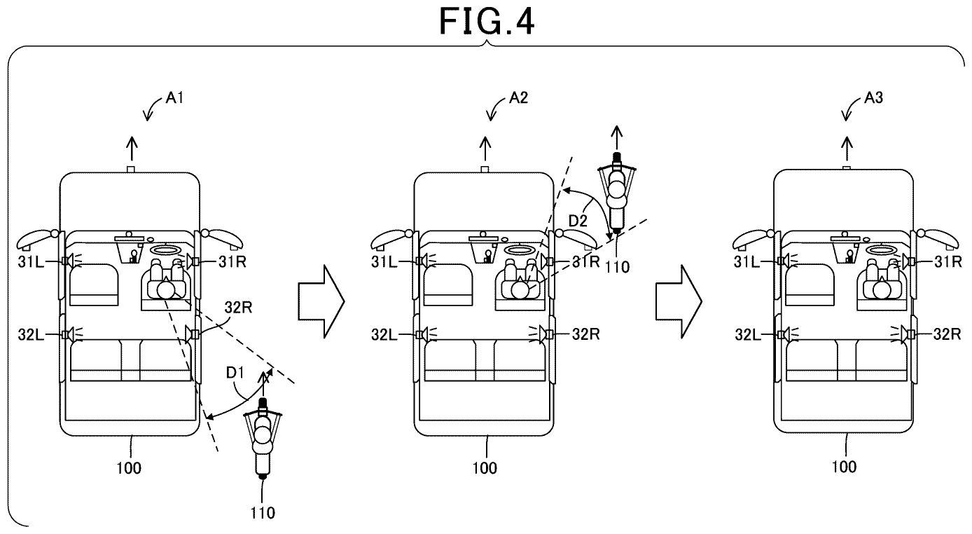

In step S10, the attention calling control section 12 executes the attention calling processing by muting as shown in FIG. 4, and advances the processing to step S5. FIG. 4 illustrates a case in which the attention calling control section 12 executes the attention calling processing by muting in a situation where a two-wheel vehicle 110 passes to the right side of the vehicle 100.

In FIG. 4, A1 shows a situation where the two-wheel vehicle 110 is approaching from behind to the right side of the vehicle 100, and the attention calling control section 12 turns off (mutes) sound output from the right rear speaker 32R in a direction D1 from the user U toward the two-wheel vehicle 110. Thus, the user U can be prompted to turn his/her attention in the direction D1 by such a change in sense of hearing that sound having been heard from the direction D1 suddenly disappears.

In FIG. 4, A2 shows a situation where the two-wheel vehicle 110 has moved ahead to the right side of the vehicle 100, and the attention calling control section 12 resumes outputting sound from the right rear speaker 32R and then turns off sound output from the right front speaker 31R in a direction D2 from the user U toward the two-wheel vehicle 110. Thus, due to an effect of muting similar to that of the situation of A1, the user U can be prompted to turn his/her attention in the direction D2.

In FIG. 4, A3 shows a situation where the two-wheel vehicle 110 has gone away from the vehicle 100, so that the two-wheel vehicle 110 is no longer recognized by the monitoring-target object recognition section 11, and the attention calling processing by muting is terminated, and sound output from the right front speaker 31R is resumed.

Note that the attention calling processing by muting may be performed by intermittently turning on and off sound output from a speaker repeatedly. In such a case, an interval at which a switch is made between turning on and off of sound output from the speaker may be made shorter according to the degree of risk of a monitoring-target object (which is set based on the distance from the vehicle 100, the speed at which the vehicle 100 is approached, or the like), for example, as the degree of risk becomes higher. When the degree of risk of the monitoring-target object is a predetermined determination level or more, an alarm sound or voice for calling attention may be outputted from a speaker in a direction in which attention is called. Further, when the degree of risk of the monitoring-target object is the predetermined determination level or more, sound from speakers other than the speaker in a direction in which attention is called may be turned down or off, and an alarm sound or voice for calling attention may be outputted from the speaker in the direction in which attention is called.

Moreover, attention may be called without completely turning off sound from a speaker, by making the output level of the speaker lower than those of the other speakers. For example, in the situation of A1 in FIG. 4, attention may be called in the direction D1 by making the output level of sound from the right rear speaker 32R lower than the output levels of sound from the left front speaker 31L, the right front speaker 31R, and the left rear speaker 32L.

In step S3, the attention calling control section 12 determines, based on control by the lighting control unit 33, whether or not the ambient lighting is lit. Then, the attention calling control section 12 advances the processing to step S20 when the ambient lighting is lit, and advances the processing to step S4 when the ambient lighting 34 is unlit.

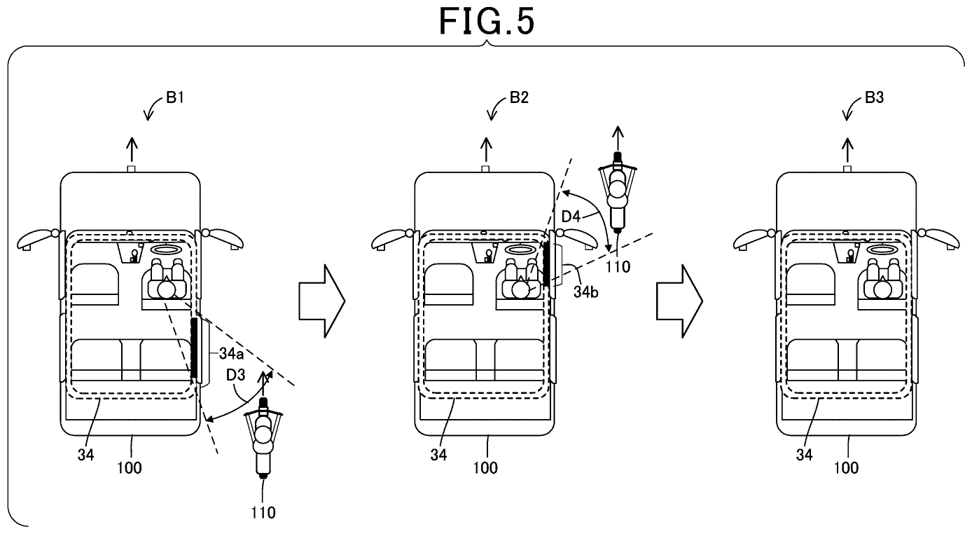

In step S20, the attention calling control section 12 executes the attention calling processing by extinguishing light as shown in FIG. 5, and advances the processing to step S5. FIG. 5 illustrates a case in which the attention calling control section 12 executes the attention calling processing by extinguishing light in a situation where the two-wheel vehicle 110 passes to the right side of the vehicle 100, as in FIG. 4 described above.

In FIG. 5, B1 shows a situation where the two-wheel vehicle 110 is approaching from behind to the right side of the vehicle 100, and the attention calling control section 12 turns off (extinguishes) light in an area 34a of the ambient lighting 34. The area 34a corresponds to a direction D3 from the user U toward the two-wheel vehicle 110. Thus, the user U can be prompted to turn his/her attention in the direction D3 by such a change in sense of sight that brightness having been visually sensed in the direction D3 suddenly disappears.

In FIG. 5, B2 shows a situation where the two-wheel vehicle 110 has moved ahead to the right side of the vehicle 100, and the attention calling control section 12 resumes lighting the area 34a of the ambient lighting 34 and then turns off light in an area 34b of the ambient lighting 34. The area 34b corresponds to a direction from the user U toward the two-wheel vehicle 110. Thus, due to an effect of extinguishing light similar to that of the situation of B1, the user U can be prompted to turn his/her attention in the direction D4.

In FIG. 5, B3 shows a situation where the two-wheel vehicle 110 has gone away from the vehicle 100, so that the two-wheel vehicle 110 is no longer recognized by the monitoring-target object recognition section 11, and the attention calling control section 12 terminates the attention calling processing by extinguishing light, and lighting of the area 34b of the ambient lighting 34 is resumed.

Note that the attention calling processing by extinguishing light may be performed by intermittently turning on and off (lighting and extinguishing) an area of the ambient lighting 34 corresponding to a direction in which attention is called repeatedly. In such a case, an interval at which a switch is made between turning on and off of the target area may be made shorter according to the degree of risk of a monitoring-target object, for example, as the degree of risk becomes higher. When the degree of risk of the monitoring-target object is a predetermined determination level or more, light for calling attention may be outputted from an area of the ambient lighting 34 in a direction in which attention is called. Further, when the degree of risk of the monitoring-target object is the predetermined determination level or more, light in areas other than the area of the ambient lighting 34 in the direction in which attention is called may be turned down or off, and light for calling attention may be outputted from the area of the ambient lighting 34 in the direction in which attention is called. Note that the light for calling attention may be in any form having a color, a light-emitting range, or a luminance different from those in states in which the degree of risk is less than the predetermined determination level.

Moreover, attention may be called without completely turning off light in a target area of the ambient lighting 34, by making the output level of the target area lower than that of the other area. For example, in the situation of B1 in FIG. 5, attention may be called in the direction D3 by making the output level of the area 34a corresponding to the direction D3 lower than the output level of the other area.

In step S4, the attention calling control section 12 executes the attention calling processing for calling attention to the two-wheel vehicle 110 traveling to the right side of the vehicle 100 by displaying an attention calling screen on the display 40, outputting voice or an alarm sound from the driver seat speaker 41, or the like, and advances the processing to step S5.

The flowchart of FIG. 3 specifies that the attention calling processing by muting precedes the attention calling by extinguishing light in steps S2, S3. In reverse, the attention calling by extinguishing light may be configured to precede the attention calling processing by muting. Moreover, when both sound output from the left front speaker 31L, the right front speaker 31R, the left rear speaker 32L, and the right rear speaker 32R and shining of the ambient lighting 34 are taking place, both the attention calling processing by muting and the attention calling processing by extinguishing light may be executed.

### 4. Other Embodiments

Although the vehicle 100 is illustrated in the above-described embodiment as a moving object in the present disclosure, the moving object in the present disclosure may be any moving object that uses the attention calling system that performs attention calling for a user aboard, and may be a flying object, a ship, or the like.

In the above-described embodiment, the attention calling system 1 that is configured by using, or as, on-board equipment mounted on the vehicle 100 is illustrated as an attention calling system in the present disclosure. As another embodiment, part or the whole of the attention calling system in the present disclosure may be configured by using the mobile terminal 50 brought into the vehicle 100, or an external communication system, such as a content server 210, outside of the vehicle 100.

When the attention calling system is configured by using the mobile terminal 50, a configuration is made such that the mobile terminal 50 recognizes a monitoring-target object through communication between the mobile terminal 50 and the on-board equipment (ADAS 2, sound control unit 30, lighting control unit 33, and the like) via the communication unit 4, and executes the attention calling processing by using the speakers (left front speaker 31L, right front speaker 31R, left rear speaker 32L, and right rear speaker 32R) and the ambient lighting 34 included in the vehicle 100. When the attention calling system is configured by using an external communication system, a configuration is made such that the external communication system recognizes a monitoring-target object through communication between the external communication system and the on-board equipment via the communication unit 4, and executes the attention calling processing by using the speakers and the ambient lighting 34 included in the vehicle 100.

In the above-described embodiment, the attention calling control section 12 recognizes the status of sound output from the speakers included in the vehicle 100, based on communication with the sound control unit 30. As another embodiment, the status of sound output from the speakers included in the vehicle 100 may be recognized based on a level of sound in a space in a vicinity of the driver seat 7 (corresponding to a boarding space in the present disclosure) that is inputted into the driver seat microphone 42. In such a case, the driver seat microphone 42 corresponds to a sound detection section in the present disclosure. Note that a sensor for detecting sound levels may be included separately. The attention calling control section 12 can execute the attention calling processing, by reducing the output level (including turning off the output) of sound from a speaker in a direction in which attention is called to less than the level of the sound in the vicinity of the driver seat 7 (boarding area) detected by the driver seat microphone 42.

The output level of sound from the speaker in the direction in which attention is called may be reduced by so-called noise canceling processing, by outputting sound that cancels out the sound detected by the driver seat microphone 42 from the speaker in the direction in which attention is called.

In the above-described embodiment, the attention calling control section 12 recognizes the status of shining of the ambient lighting 34 included in the vehicle 100, based on communication with the lighting control unit 33. As another embodiment, the status of shining of the ambient lighting 34 may be recognized by recognizing brightness in the vicinity of the driver seat, based on an image captured by the driver camera 43. In such a case, the driver camera 43 corresponds to a brightness detection section in the present disclosure. Note that a sensor that detects brightness, such as an illuminance sensor, may be included separately. The attention calling control section 12 can execute the attention calling processing, by reducing the output level (including extinguishing light) of the ambient lighting 34 in an area in a direction in which attention is called to less than a level of the brightness in the vicinity of the driver seat recognized based on an image captured by the driver camera 43.

Note that FIG. 2 is a schematic diagram showing the configuration of the attention calling system 1 that is divided into sections based on main processes to facilitate the understanding of the invention of the present disclosure. The configuration of the attention calling system 1 may be made based on other sections. The processing by each constituent element may be executed by a single hardware unit, or may be executed by a plurality of hardware units. The processing by each constituent element shown in FIG. 3 may be executed by using a single program, or may be executed by using a plurality of programs.

### 5. Configurations Supported by the Above-Described Embodiment

The above-described embodiment is a specific example of following configurations.

(Configuration 1) An attention calling system including: a monitoring-target object recognition section that recognizes a monitoring-target object existing around a moving object; and an attention calling control section that, when the monitoring-target object is recognized by the monitoring-target object recognition section, executes attention calling processing using an output device for a user aboard the moving object, the output device outputting sound or light, wherein the output device outputs sound or light from a predetermined area around a boarding position of the user in the moving object, and when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.

According to the attention calling system in configuration 1, the output level of the predetermined output via sound or light from the direction of the monitoring-target object is made lower than the output level of the predetermined output from the other direction, whereby attention can be called by utilizing such an instinct of the user as a living being as to intuitively turn his/her attention in a direction in which the output level of the predetermined output is reduced. Thus, it is possible to call attention to the monitoring-target object, while curbing inconvenience felt by the user, which can be felt in cases such as where the output level of the predetermined output, such as music, that is being outputted from the output device is reduced as a whole and attention calling voice is outputted.

(Configuration 2) The attention calling system according to configuration 1, wherein in the attention calling processing, the attention calling control section intermittently reduces the output level of the predetermined output from the direction of the monitoring-target object.

According to the attention calling system in configuration 2, the effect of calling attention of the user can be enhanced by intermittently reducing the output level of the predetermined output from the direction of the monitoring-target object.

(Configuration 3) The attention calling system according to configuration 2, wherein in the attention calling processing, the attention calling control section changes an interval at which the output level of the predetermined output from the direction of the monitoring-target object is intermittently changed, according to a degree of risk of the monitoring-target object being recognized by the monitoring-target object recognition section.

According to the attention calling system in configuration 3, the user can be made to recognize degrees of risk of the monitoring-target object, based on changing intervals at which the output level of the predetermined output from the direction of the monitoring-target object is intermittently changed.

(Configuration 4) The attention calling system according to any one of configurations 1 to 3 wherein the output device outputs sound, the attention calling system further including a sound detection section that detects sound in a boarding space in the moving object, wherein in the attention calling processing, the attention calling control section reduces a level of the predetermined output via sound from the direction of the monitoring-target object to less than a level of the predetermined output via sound from directions other than the direction of the monitoring-target object by reducing a level of sound outputted from the direction of the monitoring-target object to less than a level of the sound detected by the sound detection section.

According to the attention calling system in configuration 4, the output level of sound from the direction of the monitoring-target object can be made lower than the output level of sound from the other direction, based on an actual acoustic environment in which the user is present.

(Configuration 5) The attention calling system according to any one of configurations 1 to 4, wherein the output device outputs sound, and the attention calling control section causes the output device to output an attention calling sound from the direction of the monitoring-target object when a degree of risk of the monitoring-target object being recognized by the monitoring-target object recognition section is a predetermined determination degree or more.

According to the attention calling system in configuration 5, it can be ensured that attention is called in the direction of the monitoring-target object when the degree of risk of the monitoring-target object increases.

(Configuration 6) The attention calling system according to any one of configurations 1 to 5 wherein the output device outputs light, the attention calling system further including a brightness detection section that detects brightness in a boarding space in the moving object, wherein in the attention calling processing, the attention calling control section reduces a level of the predetermined output via light from the direction of the monitoring-target object to less than a level of the predetermined output via light from directions other than the direction of the monitoring-target object by reducing a level of brightness of light outputted from the direction of the monitoring-target object to less than a level of the brightness detected by the brightness detection section.

According to the attention calling system in configuration 6, the output level of light from the direction of the monitoring-target object can be made lower than the output level of light from the other direction, based on an actual bright and dark environment in which the user is present.

(Configuration 7) The attention calling system according to any one of configurations 1 to 6, wherein the output device outputs light, and the attention calling control section causes the output device to output attention calling light from the direction of the monitoring-target object when a degree of risk of the monitoring-target object being recognized by the monitoring-target object recognition section is a predetermined determination degree or more.

According to the attention calling system in configuration 7, it can be ensured that attention is called in the direction of the monitoring-target object when the degree of risk of the monitoring-target object increases.

(Configuration 8) An attention calling method to be executed by a computer, including: a monitoring-target object recognition step of recognizing a monitoring-target object existing around a moving object; and an attention calling control step of, when the monitoring-target object is recognized in the monitoring-target object recognition step, executing attention calling processing using an output device for a user aboard the moving object, the output device outputting sound or light, wherein the output device outputs sound or light from a predetermined area around a boarding position of the user in the moving object, and in the attention calling control step, when the monitoring-target object is recognized in the monitoring-target object recognition step in a state where a predetermined output via sound or light from the predetermined area is being performed by the output device, processing of reducing an output level of the predetermined output from a direction of the monitoring-target object to less than an output level of the predetermined output from directions other than the direction of the monitoring-target object is performed as the attention calling processing, the direction of the monitoring-target object being a direction from the user toward the monitoring-target object.

By a computer executing the attention calling method in configuration 8, operations and effects similar to those of the attention calling system in configuration 1 can be obtained.

(Configuration 9) A non-transitory computer-readable storage medium storing a program causing a computer to function as: a monitoring-target object recognition section that recognizes a monitoring-target object existing around a moving object; and an attention calling control section that, when the monitoring-target object is recognized by the monitoring-target object recognition section, executes attention calling processing using an output device for a user aboard the moving object, the output device outputting sound or light, wherein the output device outputs sound or light from a predetermined area around a boarding position of the user in the moving object, and when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.

By a computer executing the program in configuration 9, the configuration of the attention calling system in configuration 1 can be implemented.

### REFERENCE SIGNS LIST

1 attention calling system, 2 ADAS, 3 navigation apparatus, 4 communication unit, 5F front camera, 5R rear camera, 6L left side camera, 6R right side camera, 7 driver seat, 10 processor, 11 monitoring-target object recognition section, 12 attention calling control section, 20 memory, 21 program, 30 sound control unit, 31L left front speaker, 31R right front speaker, 32L left rear speaker, 32R right rear speaker, 33 lighting control unit, 34 ambient lighting, 40 display, 41 driver seat speaker, 42 driver seat microphone, 43 driver camera, 50 mobile terminal, 100 vehicle, 110 two-wheel vehicle, 200 communication network, 210 content server, U user

1. An attention calling system comprising:
a monitoring-target object recognition section that recognizes a monitoring-target object existing around a moving object; and
an attention calling control section that, when the monitoring-target object is recognized by the monitoring-target object recognition section, executes attention calling processing using an output device for a user aboard the moving object, the output device outputting sound or light, wherein
the output device outputs sound or light from a predetermined area around a boarding position of the user in the moving object, and
when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.

2. The attention calling system according to claim 1, wherein in the attention calling processing, the attention calling control section intermittently reduces the output level of the predetermined output from the direction of the monitoring-target object.

3. The attention calling system according to claim 2, wherein in the attention calling processing, the attention calling control section changes an interval at which the output level of the predetermined output from the direction of the monitoring-target object is intermittently changed, according to a degree of risk of the monitoring-target object being recognized by the monitoring-target object recognition section.

4. The attention calling system according to claim 1 wherein the output device outputs sound, the attention calling system further comprising a sound detection section that detects sound in a boarding space in the moving object,
wherein in the attention calling processing, the attention calling control section reduces a level of the predetermined output via sound from the direction of the monitoring-target object to less than a level of the predetermined output via sound from directions other than the direction of the monitoring-target object by reducing a level of sound outputted from the direction of the monitoring-target object to less than a level of the sound detected by the sound detection section.

5. The attention calling system according to claim 1, wherein
the output device outputs sound, and
the attention calling control section causes the output device to output an attention calling sound from the direction of the monitoring-target object when a degree of risk of the monitoring-target object being recognized by the monitoring-target object recognition section is a predetermined determination degree or more.

6. The attention calling system according to claim 1 wherein the output device outputs light, the attention calling system further comprising a brightness detection section that detects brightness in a boarding space in the moving object,
wherein in the attention calling processing, the attention calling control section reduces a level of the predetermined output via light from the direction of the monitoring-target object to less than a level of the predetermined output via light from directions other than the direction of the monitoring-target object by reducing a level of brightness of light outputted from the direction of the monitoring-target object to less than a level of the brightness detected by the brightness detection section.

7. The attention calling system according to claim 1, wherein
the output device outputs light, and
the attention calling control section causes the output device to output attention calling light from the direction of the monitoring-target object when a degree of risk of the monitoring-target object being recognized by the monitoring-target object recognition section is a predetermined determination degree or more.

8. An attention calling method to be executed by a computer, comprising:
a monitoring-target object recognition step of recognizing a monitoring-target object existing around a moving object; and
an attention calling control step of, when the monitoring-target object is recognized in the monitoring-target object recognition step, executing attention calling processing using an output device for a user aboard the moving object, the output device outputting sound or light, wherein
the output device outputs sound or light from a predetermined area around a boarding position of the user in the moving object, and
in the attention calling control step, when the monitoring-target object is recognized in the monitoring-target object recognition step in a state where a predetermined output via sound or light from the predetermined area is being performed by the output device, processing of reducing an output level of the predetermined output from a direction of the monitoring-target object to less than an output level of the predetermined output from directions other than the direction of the monitoring-target object is performed as the attention calling processing, the direction of the monitoring-target object being a direction from the user toward the monitoring-target object.

9. A non-transitory computer-readable storage medium storing a program causing a computer to function as:
a monitoring-target object recognition section that recognizes a monitoring-target object existing around a moving object; and
an attention calling control section that, when the monitoring-target object is recognized by the monitoring-target object recognition section, executes attention calling processing using an output device for a user aboard the moving object, the output device outputting sound or light, wherein
the output device outputs sound or light from a predetermined area around a boarding position of the user in the moving object, and
when the monitoring-target object is recognized by the monitoring-target object recognition section in a state where a predetermined output via sound or light from the predetermined area is being performed by the output device, the attention calling control section executes, as the attention calling processing, processing of reducing an output level of the predetermined output from a direction of the monitoring-target object to less than an output level of the predetermined output from directions other than the direction of the monitoring-target object, the direction of the monitoring-target object being a direction from the user toward the monitoring-target object.
